(19) United States
(12) Patent Application Publication
(10) Pub. No.: US 2026/0116270 A1
(43) Pub. Date: Apr. 30, 2026

(54) SWIVELING DEVICE FOR VEHICLE SEAT

(71) Applicant: MFI ITALY ENGINEERING S.R.L., Milano (MI) (IT)

(72) Inventors: Can ÜSTÜNBERK, Grugliasco (TO) (IT); Prasanna HIREMATH, Grugliasco (TO) (IT); Giorgio ADAMO, Grugliasco (TO) (IT); Andrea MALINCONICO, Grugliasco (TO) (IT)

(21) Appl. No.: 19/149,987

(22) PCT Filed: Jan. 25, 2024
(86) PCT No.: PCT/IB2024/050698

§ 371 Date: Jul. 22, 2025

(30) Foreign Application Priority Data
Jan. 30, 2023 (IT) 102023000001398

(51) Int. Cl. B60N 2/14; B60N 2/02; B60N 2/07

(52) U.S. Cl. CPC B60N 2/146; B60N 2/02246; B60N 2/07

(57) ABSTRACT

A swiveling device for a vehicle seat is provided. The swiveling device includes lower and upper plates, a plurality of coils being attached to one of the plates and a plurality of magnets being attached to the other one of the plates. The electromagnetic forces generated by feeding the coils with an electric current produces relative rotation between the lower plate, intended to be attached to the floor of a vehicle cockpit, and the upper plate, intended to be attached to the frame of a seat cushion. The electromagnetic thrust generates a torque, which makes the upper plate rotate relative to the lower plate, while the electromagnetic repulsion generates an axial force counteracting the weight of the vehicle seat and of a user sitting on the seat.

### TECHNICAL FIELD

The present invention relates to a swiveling device for a vehicle seat.

### BACKGROUND ART

Vehicle seats provided with a swiveling device are known and widespread.

A swiveling device allows the vehicle seat to rotate about an axis that is substantially perpendicular to the vehicle floor.

In general, a swiveling device allows a rotation of the corresponding vehicle seat over an angle of at least 90°, thus allowing the vehicle seat to pass from a first position, in which the seat is oriented towards the traveling direction of the vehicle, to a second position, in which the seat is oriented towards the adjacent vehicle door.

In this way, the swiveling device facilitates the entry of the driver or passenger into the cockpit and/or the exit therefrom.

It will be evident that swiveling devices are particularly useful for individuals with limited mobility, especially with restricted lower body strength and movement capability.

Accordingly, they can be introduced into the vehicle cockpit as an aftermarket adaptation to an existing passenger vehicle, replacing the original seat anchoring arrangement to the vehicle floor.

More in detail, swiveling devices are generally composed of two parallel plates, which are inserted between the original vehicle seat and the vehicle floor in place of the original seat anchoring arrangement, and which are rotatable relative to each other, so that a lower plate coupled to the vehicle floor can be kept stationary and an upper plate coupled to the seat cushion frame can rotate relative to the lower plate.

Such plates are usually separated by an off-center bearing allowing the seat to rotate from the first position, in which the seat is oriented towards the traveling direction of the vehicle, to the second position, in which the seat is oriented towards the adjacent vehicle door, and at the same time to move the seat so that it protrudes over the door sill.

In order to selectively allow or prevent rotation of the upper plate relative to the lower plate, a locking pin (for instance a vertically oriented locking pin) is usually provided, and a control lever is used for switching the locking pin from a locking position (in which relative rotation of the plates is prevented) to an unlocking position (in which relative rotation of the plates is allowed).

Once the locking pin has been switched to the unlocking position, rotation of the upper plate relative to the lower plate is mechanically or electromechanically driven.

DE102017007418 discloses a vehicle seat, comprising a seat cushion and a seat backrest, which is provided with a sliding device, for moving at least the seat cushion in the longitudinal direction of the motor vehicle along a pair of rails, and with a swiveling device, for rotating at least the seat cushion relative to the vehicle floor about a vertical axis. The sliding device and the swiveling device are driven by conventional electric motors.

Since the integrity of the seat is crucial for occupant protection in a collision, vehicle adaptation companies need to ensure that the adaptation does not compromise the safety of the seat or weaken the surrounding structure of the vehicle.

However, since there are no applicable standards, a level of self-regulation is required.

In addition, swiveling devices according to prior art have a bulky structure and a remarkable weight, and their assembly and installation are complex and time-consuming operations.

Furthermore, swiveling devices of known type are usually based on a mechanical cooperation between the lower and upper plates. For instance, such plates are made as mutually meshing toothed plates.

This leads to a poor reliability and to a high risk of malfunctioning, especially in presence of dust and dirt.

The main object of the present invention is to obviate to the above-mentioned drawbacks, by providing a swiveling device with a simple and light structure, allowing to make the assembly and installation operations easier and quicker.

Another object of the present invention is to provide a swiveling device with an improved reliability.

These and other objects are achieved by a swiveling device as claimed in the appended claims.

### SUMMARY OF INVENTION

The swiveling device according to the invention exploits electromagnetic forces for obtaining the relative rotation between a lower plate, intended to be attached to the floor of a vehicle cockpit, and an upper plate, intended to be attached to the frame of a seat cushion.

According to the invention, a plurality of coils are attached to one plate of the swiveling device, while a plurality of magnets are attached to the other plate of the swiveling device.

According to a preferred embodiment of the invention, a plurality of coils are attached to the stationary lower plate, while a plurality of magnets are attached to the rotating upper plate.

It is evident that this embodiment is particularly advantageous, since the coils, which have to be fed with an electric current, are on the stationary plate of the swiveling device.

Nevertheless, according to an alternative embodiment of the invention a plurality of magnets could be attached to the stationary lower plate, while a plurality of coils could be attached to the rotating upper plate.

By adequately feeding the coils, an electromagnetic thrust and a resulting torque can be generated, which torque makes the upper plate rotate relative to the lower plate.

According to a preferred embodiment of the invention, the coils are arranged so as to achieve the configuration of a three-phase motor winding which is fed with an alternate current and the magnets are correspondingly arranged in an alternate setting: by tuning with an appropriate control law each phase of the three-phase winding, a desired thrust along a tangential direction can be obtained for driving the upper plate in rotation relative to the lower plate.

In the swiveling device according to the invention, while the electromagnetic thrust is used for generating the relative rotation between the plates, the electromagnetic repulsion is advantageously exploited for generating a force in the axial direction that counteracts the weight of a user sitting on the vehicle seat, and that can preferably withstand the weight of a user sitting on the vehicle seat.

Devices including a first plate carrying a plurality of coils and a second plate carrying a plurality of magnets are known form the art.

By way of example, US 2023/017545 discloses an actuator for generating vibration that includes a driving coil, a first magnet facing an upper surface of the driving coil and a second magnet facing a lower surface of the driving coil. If a power of appropriate size and direction is applied to the driving coil, a magnetic force is generated at the upper and lower portions of the driving coil at the same time, and the generated magnetic force is simultaneously transmitted to the first magnet and the second magnet, respectively, so that the first magnet and the second magnet rotate with an increased driving force, thereby enhancing the vibration force by rotational drive.

US 2006/105877 relates to a servo driver for motor vehicles which includes an electromechanical energy converter having a disc rotor comprising an armature disc through which a current flows. Magnets are mounted on one or both sides next to the disc rotor. When the electrical conductors which are formed or are mounted on the disc rotor are energized, a torque is produced through the influence of the magnetic field, whereby this torque causes the disc rotor to rotate.

US 2017/248146 discloses a blower assembly for a vehicle seat. The blower assembly comprises a housing and a stator, which is coupled to the housing and comprises a plurality of driving coils. The blower assembly further comprises a rotor rotatably coupled to the housing about a rotational axis, with the rotor comprising a plurality of permanent magnets arranged to generate a flux concentrated on the driving coils. The blower assembly further comprises an impeller coupled to the rotor to rotate about the rotational axis to generate a flow of air through the passage.

WO 2016/071742 describes an actuating device for actuating a cable having a motor assembly which comprises a rotor and a printed circuit board. The rotor has a plurality of alternatively polarized magnets, and the printed circuit board has a plurality of coils. The plurality of coils creates a magnetic field when supplied with a current, which, in turn, causes the rotor to rotate.

However, none of the devices disclosed in the above-documents discloses or suggests to exploiting at the same time both the electromagnetic thrust and the electromagnetic repulsion generated between the magnets and the coils when the latter are energized

### BRIEF DESCRIPTION OF DRAWINGS

Further features and advantages of the invention will become more evident from the detailed description of a preferred embodiment thereof, given by way of non limiting example, with reference to the attached drawings, in which:

FIG. 1 is a schematic perspective view of a vehicle seat provided with a swiveling device according to the invention;

FIG. 2 is a perspective view of the swiveling device according to the invention;

FIG. 3 is an exploded view of the swiveling device of FIG. 2;

FIG. 4a shows, in a cross-sectional view, a detail of the swiveling device of FIGS. 2 and 3 relating to the locking system of such swiveling device, shown in a first configuration;

FIG. 4b shows, in a cross-sectional view, the detail of FIG. 4a, shown in a second, different configuration.

### DESCRIPTION OF EMBODIMENTS

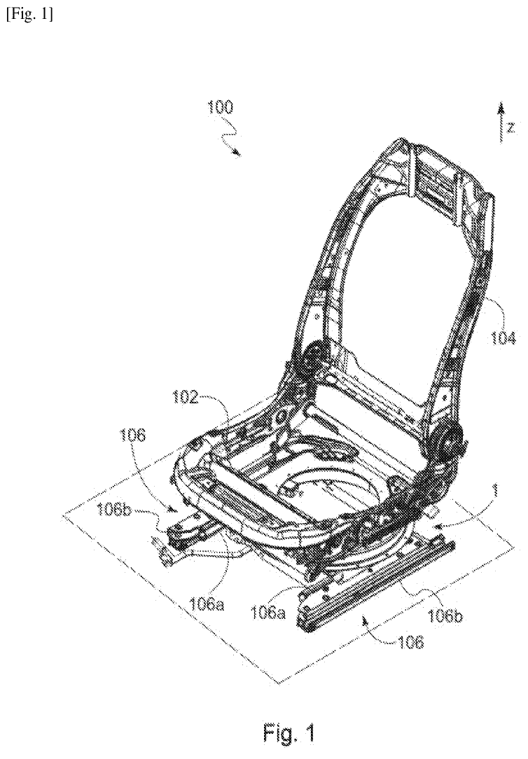

A vehicle seat 100 is schematically shown in [FIG. 1].

The vehicle seat 100 generally includes a seat cushion, including a seat cushion frame 102 and seat cushion foam body (not shown) mounted to the seat cushion frame, and a seat backrest, including a seat backrest frame 104 and seat backrest foam body (not shown) mounted to the seat backrest frame.

In a known manner, the seat cushion frame 102 is mounted on a pair of tracks 106. In detail, the seat cushion frame 102 is fastened to the upper rails 106a of the tracks 106, while the lower rails 106b of the tracks 106 are fixedly fastened to the vehicle floor 200, said upper rails being slidably connected to said lower rails.

The vehicle seat 100 is provided with a swiveling device 1, allowing the vehicle seat 100 to rotate relative to the vehicle floor 200 about a vertical direction Z, i.e. a direction that is substantially perpendicular to the vehicle floor 200.

The swiveling device 1 is interposed between the seat cushion frame 102 and the vehicle floor 200 and includes a stationary (i.e. non-rotating) portion and a rotating portion.

In the shown embodiment, the stationary portion of the swiveling device 1 is connected to the upper rails 106a of the tracks 106, while the rotating portion of said swiveling device is connected to seat cushion frame 102.

Thanks to this arrangement, the swiveling device 1 as a whole can move with the vehicle seat 100, when, for instance, said vehicle seat slides along the tracks 106; at the same time, the vehicle seat 100 can rotate relative to the vehicle floor (for instance, when a user enters the vehicle cockpit or exits therefrom).

In an alternative embodiment, the stationary portion of the swiveling device could be connected to the vehicle floor, while the rotating portion of said swiveling device could be connected to the lower rails of the tracks of the sliding device.

With this arrangement, the sliding device as a whole could rotate with the vehicle seat, when, for instance, said vehicle seat rotates thanks to the swiveling device; at the same time, the vehicle seat could slide along the rails of the sliding device.

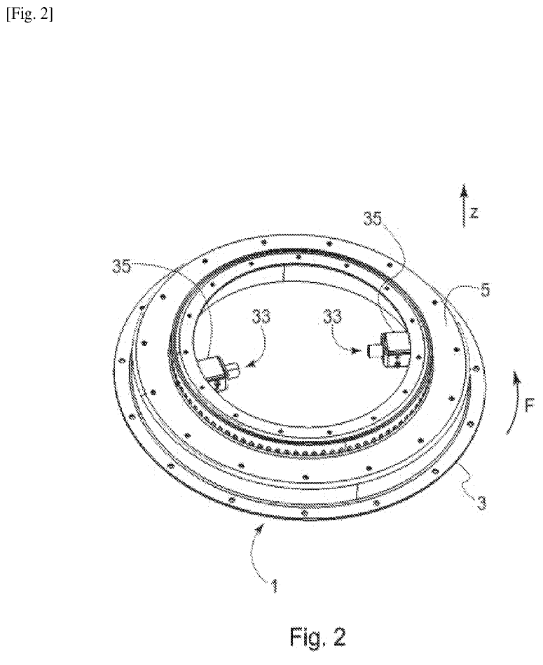

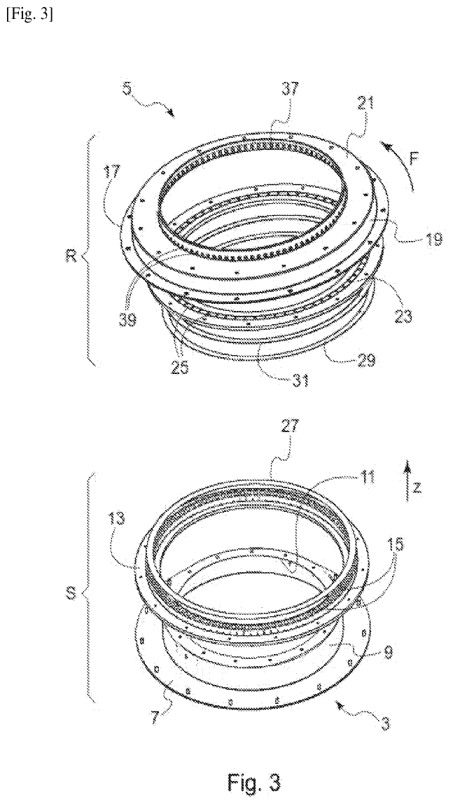

The swiveling device according to the invention is shown in greater detail in FIGS. 2 and 3.

The swiveling device 1 includes a lower plate or stationary plate 3 and an upper plate or rotating plate 5.

The lower and upper plates 3, 5 preferably have an overall substantially annular shape.

The lower plate 3 includes a peripheral annular rim 7, a cylindrical wall 9, upwardly projecting form the inner edge of the annular rim 7, and an annular lip 11, inwardly projecting from the upper edge of the cylindrical wall 9.

A first supporting ring 13 can therefore be fitted around the cylindrical wall 9 and fastened to the annular rim 7, for instance by screws.

A first annular seal (not shown) can also be provided between the lower plate 3 and the first supporting ring 13 for compensating mechanical tolerances and geometrical irregularities.

The first annular seal can be made, for instance, of rubber.

A plurality of coils 15 are mounted on the first supporting ring 13, along its circumference.

The coils 15 are preferably mounted along the whole circumference of the first supporting ring 13 and they are densely and evenly distributed along the whole circumference of the first supporting ring 13.

The coils 15 are made, for instance, of copper.

The coils 15 are preferably made so as to withstand working temperature up to 155° C. (NEMA insulation class F).

The lower plate 3 and the first supporting ring 13 carrying the coils 15 form the stationary (i.e. non-rotating) portion S of the swiveling device 1.

The upper plate 5 includes a peripheral annular rim 17, a cylindrical wall 19, upwardly projecting from the inner edge of the annular rim 17, and an annular cover 21, inwardly projecting from the upper edge of the cylindrical wall 19.

A second supporting ring 23 can therefore be fitted inside the cylindrical wall 19 and fastened to the annular cover 21, for instance by screws.

A second annular seal 31 can also be provided between the upper plate 5 and the second supporting ring 23 for compensating mechanical tolerances and geometrical irregularities.

The second annular seal 31 can be made, for instance, of rubber.

A plurality of magnets 25 are mounted on the second supporting ring 23, along its circumference.

The magnets 25 are preferably mounted along the whole circumference of the second supporting ring 23 and they are densely evenly distributed along the whole circumference of the second supporting ring 23.

The magnets 25 are, for instance, neodymium magnets, such as N42M magnets.

The magnets 25 are preferably made so as to withstand working temperature up to 100° C.

The upper plate 5 and the second supporting ring 23 carrying the magnets 25 form the rotating portion R of the swiveling device 1.

The inner diameter of the annular cover 21 of the upper plate 5 is substantially the same as or slightly larger than the diameter of the cylindrical wall 9 of the lower plate 3, so that the upper plate 5 can be fitted onto the lower plate 3.

The height of the cylindrical wall 19 of the upper plate 5 is substantially the same as or slightly larger than the sum of the thickness of the assembly consisting of the first supporting ring 13 and the coils 15 carried thereby and the thickness of the assembly consisting of the second supporting ring 23 and the magnets 25 carried thereby.

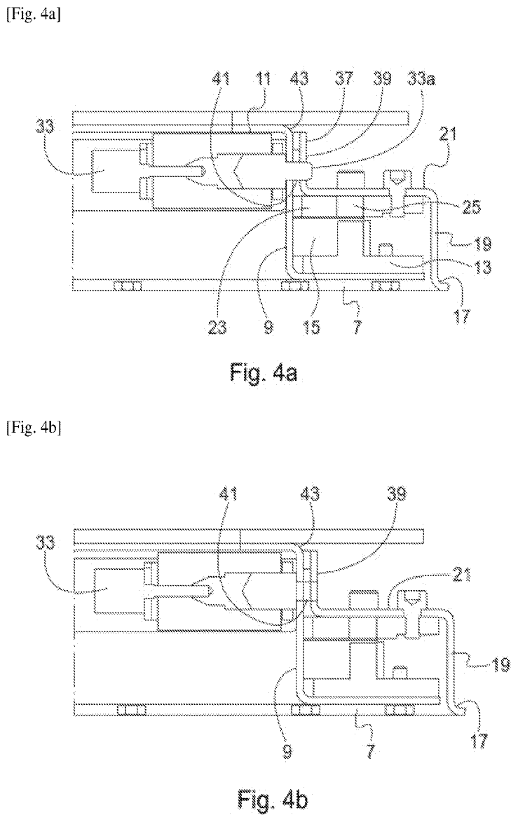

As a result, when the upper plate 5 is fitted on the lower plate 3, the second supporting ring 23 is superimposed to the first supporting ring 13 and the coils 15 face the magnets 25 along an axial direction (in this respect, see also FIGS. 4a, 4b)

The swiveling device 1 further includes a feeding system (not shown) for supplying the coils 15 with an electric current, and a control unit (not shown) for controlling the electric current fed to said coils.

The feeding system of the swiveling device can be advantageously integrated with or connected to the electric system of the vehicle on which the swiveling device is mounted.

In this way, the arrangement of an electric motor is obtained, in which the motor stator is formed by the stationary portion S of the swiveling device 1 and the motor rotor is formed by the rotating part R of the swiveling device.

Advantageously, the coils 15 can be grouped in a plurality of subsets of coils and the control unit is configured to feed each subset of coils autonomously and independently from the other subsets of coils.

In a preferred embodiment of the invention, the coils 15 are grouped in a plurality of subsets of coils so that a three-phase motor winding is obtained, and the control unit is configured for tuning each phase separately.

By feeding the coils with an electric current, an electromagnetic thrust, which is oriented along a tangential direction F relative to the perimeters of the first and second supporting rings 13, 23, is generated; and an electromagnetic repulsive force, which is oriented along a direction Z perpendicular to the planes on which the first and second supporting rings 13, 23 lie, is generated.

The electromagnetic thrust allows the upper plate to rotate relative to the lower plate.

Such electromagnetic thrust is controlled by tuning the supply of electric current to each subset of coils.

The electromagnetic repulsive force acts as a magnetic suspension, counteracting the normal force applied by the weight of the seat and of the user occupying the seat, thus reducing the friction at the contact area between the stationary portion and the rotary portion of the swiveling device.

In order to further reduce such friction, the first and second supporting rings 13, 23 can be provided with a respective annular interface element 27, 29 made of a low friction coefficient material.

The stationary portion S and the rotary portion R of the swiveling device 1 preferably contact each other only at the interface elements 27, 29.

For instance, polytetrafluoroethylene (PTFE), also known as Teflon, can be used for manufacturing the annular interface elements 27, 29.

A locking mechanism is preferably provided for selectively locking and unlocking rotation of the rotating portion R of the swiveling device 1 relative to the stationary portion S of said swiveling device 1.

Thanks to the provision of such locking mechanism, the lower and upper plates 3, 5 of the swiveling device 1 are firmly kept in a given position when said swiveling device is at rest. In addition, rotation of the swiveling device can be prevented, even if the coils are inadvertently fed with an electric current.

In the preferred embodiment of the invention shown in the Figures, such locking mechanism includes one or more radial locking pins 33. More particularly, two locking pins 33 arranged at 180° with respect to each other are provided.

The locking mechanism of the swiveling device 1 is also shown in greater detail in FIGS. 4a and 4b.

Each locking pin 33 is mounted on a flange 35 fastened to the swiveling device, more particularly to the cylindrical wall 9 of the lower plate 3.

At the location of each locking pin 33, the cylindrical wall 9 of the lower plate 3 is provided with corresponding through-hole 41, allowing the tip 33a of the locking pin to pass through said cylindrical wall 9.

The upper plate 5 is provided with a raised crown 37, upwardly projecting from the inner edge of the annular cover 21 and provided with a plurality of through-holes 39.

The through-holes 39 are preferably provided along the whole circumference of the crown 37 of the upper plate and they are densely and evenly distributed along the whole circumference of the crown 37 of the upper plate.

The overall height of the cylindrical wall 9 of the lower plate 3 is substantially the same as or larger than the sum of height of the cylindrical wall 19 of the upper plate 5 and of the crown 37 of said upper plate.

The through-hole(s) 41 in the cylindrical wall 9 is/are at the same height as the through-holes 39 in the crown 37.

A through-hole 39 of the crown 37 of the upper plate can therefore be brought into alignment (in the radial direction) with the through-hole 41 of the cylindrical wall 9 of the lower plate, so that the tip 33a of a locking pin 33 can pass through both said through-hole 39 of the crown 37 of the upper plate and said through-hole 41 of the cylindrical wall 9 of the lower plate, thus preventing said upper plate from rotating relative to said lower plate.

Each locking pin 33 is controllable for being switched from a locking configuration, in which its tip 33a passes through both the through-hole 39 of the raised crown 37 of the upper plate and the through-hole 41 of the cylindrical wall 9 of the lower plate (see [FIG. 4a]), to an unlocking configuration, in which its tip 33a is retracted from both said through-hole 39 of said raised crown 37 of the upper plate and said through-hole 41 of the cylindrical wall 9 of the lower plate (see [FIG. 4b]).

In this latter, unlocking configuration, rotation of the upper plate relative to the lower plate is allowed.

In a preferred embodiment of the invention, switching of the locking pin 33 between the locking configuration and the unlocking configuration is controlled by a solenoid: when the solenoid is de-energized, the locking pin 33 is in the locking configuration; when the solenoid is energized, the locking pin is brought to the unlocking configuration.

It can be noted that using radial locking pins allows to reduce the overall size of the swiveling device (compared to, for instance, swiveling devices using axial locking pins), since the free space inside the annular plates 3, 5 of the device can be advantageously exploited for mounting such locking pins.

A control element, such a control push-button, can be operated by the user for switching the locking pin(s) 33 to the unlocking configuration (by energizing the respective solenoid(s)) and for simultaneously supplying the coils 15 with an adequately tuned electric current.

As a result, the electromagnetic repulsive force generated between the coils 15 and the magnets 25 will act as a magnetic suspension, counteracting the weight of the seat and of the user, and the electromagnetic thrust generated between the coils 15 and the magnets 25 will generate a torque making the upper plate 5 of the swiveling device rotate relative to the lower plate 3 of said swiveling device and, as a consequence, making the seat rotate relative to the vehicle floor.

Once the new desired position is reached, by releasing the control push-button supply of electric current to the coils will be stopped and, at the same time, the locking pin(s) will be switched to the locking configuration (by de-energizing the respective solenoid(s)).

It will be evident from the above that the invention reaches the objects set forth above, since the construction and operation of the swiveling device are easy and reliable and mechanical cooperation between stationary components and rotating components of the swiveling device is avoided.

It will be also evident that the preferred embodiment shown in the figures and described in detail here above has been given by way of non-limiting example and many variants and modification within the reach of the person skilled in the art are possible without departing from the scope of the invention as defined by the appended claims.

1: A swiveling device for a vehicle seat, including a lower plate and an upper plate fitted on the lower plate,
wherein one of the lower plate and upper plate carries a plurality of coils and the other one of the lower plate and upper plate carries a plurality of magnets,
wherein the coils face the magnets along an axial direction,
wherein the swiveling device further includes a feeding system for supplying the coils with an electric current, and a control unit for controlling the electric current fed to the coils,
wherein an electromagnetic thrust is generated when the coils are supplied with the electric current and is used for generating a relative rotation between the lower plate and the upper plates, and
wherein an electromagnetic repulsion is generated when the coils are supplied with the electric current and is used for generating a force in the axial direction that counteracts a weight of a user sitting on the vehicle seat.

2: The swiveling device according to claim 1, wherein the lower plate and the upper plates have an overall substantially annular shape, wherein one of the lower plate and upper plate carries a first supporting ring with the coils arranged along a circumference of the first supporting ring, and the other one of the lower plate and upper plate carries a second supporting ring with the magnets arranged along a circumference of the second supporting ring.

3: The swiveling device according to claim 2, wherein the coils are densely and evenly distributed along the circumference of the first supporting ring and the magnets are densely and evenly distributed along the circumference of the second supporting ring.

4: The swiveling device according to claim 2, wherein a first annular seal is provided between the one of the lower plate and upper plate and the first supporting ring, and a second annular seal is provided between the other one of the lower plate and upper plate and the second supporting ring.

5: The swiveling device according to claim 1, wherein the lower plate and upper plate are provided with respective interface elements made of a low friction coefficient material, the lower plate and the upper plate contacting each other only at the interface elements.

6: The swiveling device according to claim 1, wherein the coils are grouped in a plurality of subsets of coils and the control unit is configured to control the feeding system for feeding each subset of coils autonomously and independently from the other subsets of coils.

7: The swiveling device according to claim 6, wherein the coils are arranged in a three-phase winding configuration and the control unit is configured to control the feeding system for feeding each phase of the three-phase winding configuration autonomously and independently from the other phases of the three-phase winding configuration.

8: The swiveling device according to claim 1, wherein the swiveling device includes a locking mechanism for selectively allowing or preventing rotation of the upper plate relative to the lower plate.

9: The swiveling device according to claim 8, wherein the locking mechanism includes one or more radial locking pins, the one or more radial locking pins being switchable from a locking configuration, in which they engage both the lower plate and the upper plate and prevent a relative rotation between the lower plate and the upper plate, to an unlocking configuration, in which they do not engage both the lower plate and the upper plate and allow a relative rotation between the lower plate and the upper plate.

10: The swiveling device according to claim 1, wherein the lower plate carries the coils and the upper plates carries the magnets.

11: A vehicle seat comprising a seat cushion, including a seat cushion frame and a seat cushion foam body mounted to the seat cushion frame, and a seat backrest, including a seat backrest frame and a seat backrest foam body mounted to the seat backrest frame, and further comprising a pair of tracks, each track including a lower rail and an upper rail, slidably connected to the lower rail, wherein the vehicle seat is provided with the swiveling device of claim 1 and wherein the lower plate is fastened to the upper rails of the tracks and the upper plate is fastened to the seat cushion frame.

12: A vehicle seat comprising a seat cushion, including a seat cushion frame and a seat cushion foam body mounted to the seat cushion frame, and a seat backrest, including a seat backrest frame and a seat backrest foam body mounted to the seat backrest frame, and further comprising a pair of tracks, each track including a lower rail and an upper rail, slidably connected to the lower rail, wherein the vehicle seat is provided with the swiveling device of claim 1 and wherein the upper plate is fastened to the lower rails of the tracks.
